(19) United States
(12) Patent Application Publication
(10) Pub. No.: US 2025/0217649 A1
(43) Pub. Date: Jul. 3, 2025

(54) Method for Reducing a Neural Network

(71) Applicant: MEDIATEK INC., Hsin-Chu (TW)

(72) Inventors: Yun-Wei Tsai, Hsincu City (TW); Po-Wei Chung, Hsinchu City (TW); Chi-Bang Kuan, Hsinchu City (TW)

(73) Assignee: MEDIATEK INC., Hsin-Chu (TW)

(21) Appl. No.: 18/399,651

(22) Filed: Dec. 28, 2023

(51) Int. Cl. G06N 3/082

(52) U.S. Cl. CPC G06N 3/082

(57) ABSTRACT

A method for reducing a neural network includes compiling the neural network by a reference compiler to rearrange reference weights, manipulating a reference tensor inputted to the neural network to output reference tensors, compiling the neural network by a user compiler to rearrange user weights, manipulating the reference tensor inputted to the neural network to output a user tensor, if a reference tensor of a last layer of the neural network is inconsistent with the user tensor, then a network reducer sorting and partitioning the neural network into a plurality of sub-networks each containing at least one layer. If the user tensor is inconsistent with a corresponding reference tensor, and the network reducer is unable to further partition the sub-network, then output the sub-network to a data reducer. The data reducer simplifies the reference tensor inputted to the corresponding sub-network and simplifies corresponding user weights.

### BACKGROUND

In the deep learning domain, compiling bugs include compiler errors, miscompilation errors, and other hardware/software errors. The compiler errors are generated when no compiling results are generated. The miscompilation errors are generated when the compiled result has a wrong inference for given input data. Other hardware/software errors may include false neural network operator implementations. The compiling bugs require the users to provide the neural network model and its associated input data to reproduce the error encountered at user side.

However, the original network model with the above issues may contain hundreds to thousands of neural network operators (or called layers) that process the data in a layer by layer manner. It is a time-consuming and labor-intensive process to identify the exact region of the network model that causes the error. Besides, the data of the network models, including weights and input tensors, may contain sensitive information that the users are not willing to provide. Therefore, fake models with random weights and random data are provided instead. However, random data is insufficient to reproduce the exact error encountered at the user side because the error may only occur for specific input data. In other words, the error may be data dependent. Moreover, the miscompilation errors are very difficult to be identified.

Therefore, a method for identifying compiling bugs in a neural network which can provide the exact region and the corresponding effective input tensor for the exact region is needed.

### SUMMARY

In an embodiment, a method for reducing a neural network includes compiling the neural network by a reference compiler to rearrange reference weights, manipulating a reference tensor inputted to the neural network with the reference weights to output a reference tensor for each layer of the neural network, compiling the neural network by a user compiler to rearrange user weights, manipulating the reference tensor inputted to the neural network with the user weights to output a user tensor for the neural network, if a reference tensor of a last layer of the neural network is inconsistent with the user tensor, then a network reducer sorting and partitioning the neural network into a plurality of sub-networks each containing at least one layer, compiling the plurality of sub-networks to rearrange user weights of the sub-networks, and manipulating a reference tensor inputted to a corresponding sub-network with corresponding user weights to output a user tensor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a neural network bug identifier according to an embodiment of the present invention.

FIG. 2A shows a neural network according to an embodiment of the present invention.

FIG. 2B shows a neural network according to an embodiment of the present invention.

FIG. 2C shows a sub-network retrieved from partitioning the neural network in FIGS. 2A and 2B.

FIG. 2D shows a process performed by a network reducer to identify the layers of the neural network in FIGS. 2A and 2B which contain compiling bugs.

FIG. 3 is a flowchart of a method for operation of a reference processor and a network reducer according to an embodiment of the present invention.

FIG. 4 is a flowchart of a method for operation of a data reducer according to an embodiment of the present invention.

### DETAILED DESCRIPTION

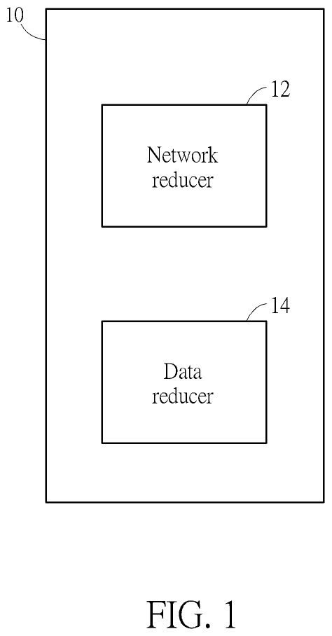

FIG. 1 is a block diagram of a neural network bug identifier 10 according to an embodiment of the present invention. The neural network bug identifier 10 comprises a network reducer 12 and a data reducer 14. The network reducer 12 is used to receive a neural network, and output sub-networks with reference tensors and reference weights that can be used to reproduce compiling bugs. The sub-networks are inputted to the data reducer 14 to reduce the reference tensors and reference weights.

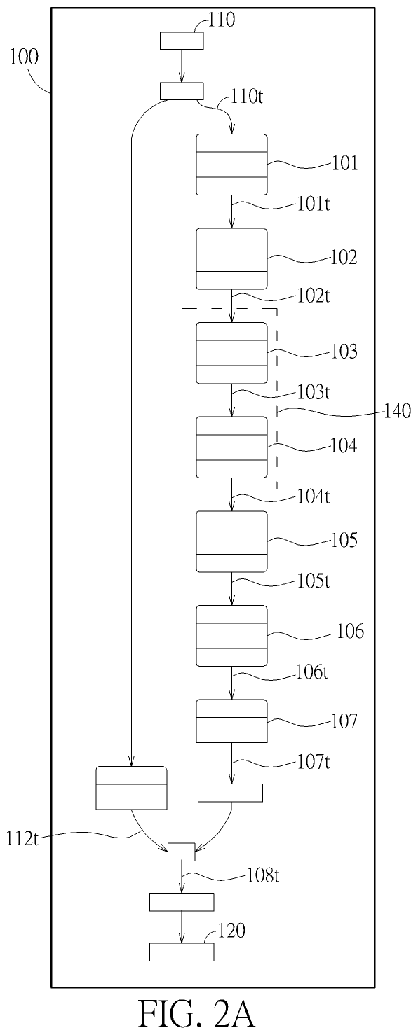

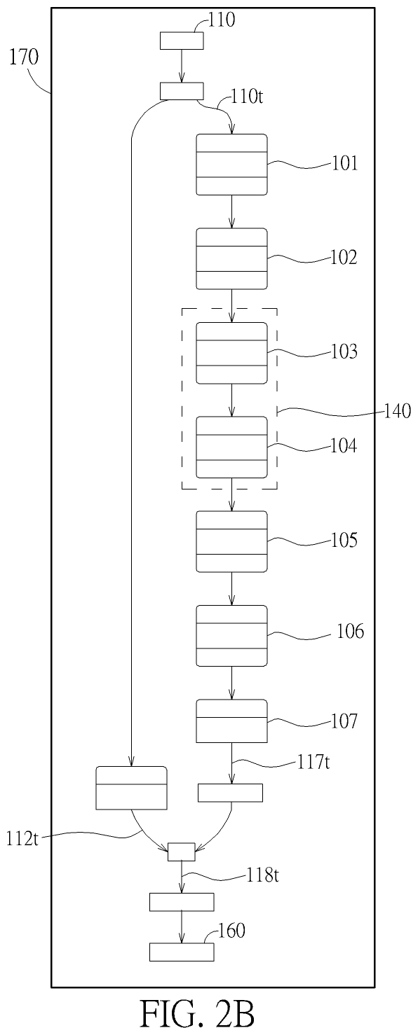

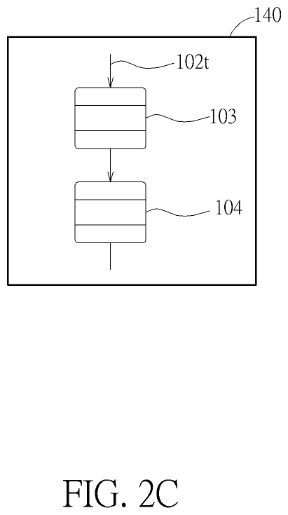

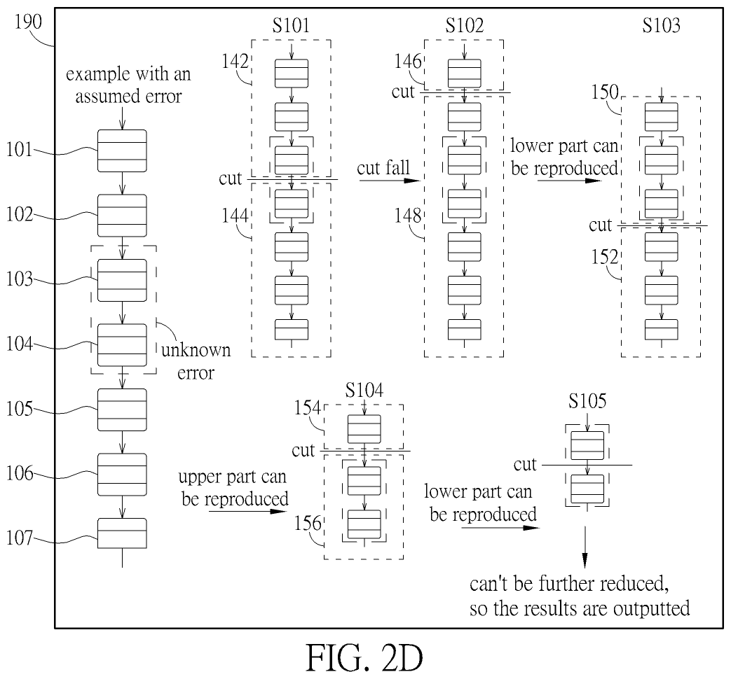

FIGS. 2A and 2B show a neural network 100 according to an embodiment of the present invention. In FIG. 2A, initially the neural network 100 is compiled by a reference compiler to rearrange reference weights of the layers 101, 102, 103, 104, 105, 106, 107 of the neural network 100. After compilation, an input tensor 110 is quantized to generate a reference tensor 110t. The reference tensor 110t is inputted to the neural network 100 to generate reference tensors 101t, 102t, 103t, 104t, 105t, 106t, 107t for each of the layers 101, 102, 103, 104, 105, 106, 107 according to the reference weights of the layers 101, 102, 103, 104, 105, 106, 107. The reference tensor 110t is also processed, such as resized, to generate a tensor 112t. The tensor 112t and the reference tensor 107t are added together to generate a reference tensor 108t. The reference tensor 108t is then processed, such as quantized, to generate a reference tensor 120. The reference tensors 101t, 102t, 103t, 104t, 105t, 106t, 107t, 108t, 120 are recorded for later usage.

In FIG. 2B, initially the neural network 100 is compiled by a user compiler to rearrange user weights of the layers 101, 102, 103, 104, 105, 106, 107 of the neural network 100. After compilation, the input tensor 110 is quantized to generate a reference tensor 110t. The reference tensor 110t is inputted to the neural network 100 to generate a user tensor 117t at the output of the layer 107 according to the user weights of the layers 101, 102, 103, 104, 105, 106, 107. The reference tensor 110t is also processed, such as resized, to generate a tensor 112t. The tensor 112t and the user tensor 117t are added together to generate a user tensor 118t. The user tensor 118t is then processed, such as quantized, to generate a user tensor 160. The user tensor 160 is then compared with the reference tensor 120. If the user tensor 160 is the same as the reference tensor 120, then no compiling bug is to be identified. If the user tensor 160 is different from the reference tensor 120, then the neural network 100 is sorted and partitioned to try to identify compiling bugs.

In FIG. 2B, if the user tensor 160 is different from the reference tensor 120, then the neural network 100 is inputted to the network reducer 12 to be sorted and partitioned to retrieve a plurality of sub-networks each containing at least one layer. FIG. 2C shows a sub-network 140 retrieved from partitioning the neural network 100 in FIG. 2B. The sub-network 140 comprises layers 103, 104. Suppose in the neural network 100, compiling bugs would be reproduced only when hardware optimization is performed on layers 103, 104 together based on the user compiler. That is, if hardware optimization is performed on layers 103 and 104 separately with other layers (e.g. layers 102 and 103 are optimized together without layer 104; or layers 104 and 105 are optimized together without layer 103), the compiling bugs would not be reproduced due to their correct hardware optimization and compilation. Moreover, since only the sub-network 140 contains compiling bugs, only the sub-network 140 is required to report the compiling bugs, which contains a lot less layers than the whole neural network 100. Further, the reference weights and the reference tensor 102t of the sub-network 140 can be reduced by flipping some of their elements from non-zeros to zeros. If the sub-network 140 with the reduced reference tensor 102t can fully reproduce the errors, the compiling bugs exist only in the sub-network 140 with the reduced reference tensor 102t and corresponding hardware optimization of layers 103 and 104. The embodiment in the present invention takes hardware optimization for example, but the compiling bugs are not limited to hardware errors. Any software and hardware error may produce the compiling bugs.

FIG. 2D shows a process 190 performed by a network reducer to identify the layers (i.e. layers 103 and 104) which contain compiling bugs according to an embodiment of the present invention. In step S101, the neural network 100 is partitioned at the end of layer 103 to retrieve two sub-networks 142, 144. The first sub-network 142 contains layers 101-103 of the neural network 100. The second sub-network 144 contains layers 104-107 of the neural network 100. To verify if the first sub-network 142 contains compiling bugs, the reference tensor 110t is inputted to layer 101 for the first sub-network 142 to output a user tensor. The user tensor output by the first sub-network 142 is compared with the reference tensor 103t. If the user tensor outputted by the first sub-network 142 is the same as the reference tensor 103t, then the first sub-network 142 contains no compiling bugs. If the user tensor output by the first sub-network 142 is different from the reference tensor 103t, then the first sub-network: 142 contains compiling bugs because errors are reproduced. In step S101, the user tensor outputted by the first sub-network 142 would be the same as the reference tensor 103t, and the user tensor outputted by the first sub-network 144 would be the same as the reference tensor 107t because the hardware optimization is not performed on layer 103 together with layer 104. Therefore, the compiling bugs are not reproduced, indicating the partition at the end of layer 103 fails. Then, in step S102, a second cut is generated between layers 101 and 102 to partition the neural network 100 into two sub-networks 146 and 148, the sub-network 146 is unable to reproduce the compiling bugs, and the sub-network 148 is able to reproduce the compiling bugs due to the hardware optimization with layers 103 and 104 together. Therefore, the sub-network 148 is chosen and saved to perform further operation. In step S103, a new cut is generated between layers 104 and 105 to partition the sub-network 148 into two sub-networks 150 and 152, and the sub-network 150 can reproduce the compiling bugs while the sub-network 152 cannot reproduce the compiling bugs. Therefore, the sub-network 150 is chosen and saved to perform further operation. In step S104, a new cut is generated between the layers 102 and 103 to partition the sub-network 150 into two sub-networks 154 and 156, and the sub-network 156 can reproduce the compiling bugs while the sub-network 154 cannot reproduce the compiling bugs. Therefore, the sub-network 156 is chosen and saved to perform further operation. In step S105, the sub-network 156 cannot be further partitioned because the sub-network 156 contains layers 103 and 104 which have been partitioned in step S101, and the partition failed in step S101. Therefore, the sub-network 156 is outputted to the data reducer to further reduce the user weights and reference tensor 102t.

A neural network bug identifier that reduces the neural network 100 by partitioning it into smaller sub-networks that can still reproduce the compiling bugs is proposed. In addition, the data reducer of the bug identifier reduces the user weights and reference tensor inputted to the sub-network to remove as much irrelevant data to reproduce the compiling bugs as possible. The input of the bug identifier is the neural network 100 with the input tensor 110 and reference weights. The output of the bug identifier is the sub-network 140 with a tensor reduced from the reference tensor 102t and weights reduced from the user weights of layers 103 and 104. The benefits of this embodiment include differential testing, outputting small sub-network, the efficient network reducer with fast reduction process, reporting multiple regions, and keeping the shape of data unchanged for reproducing exact errors.

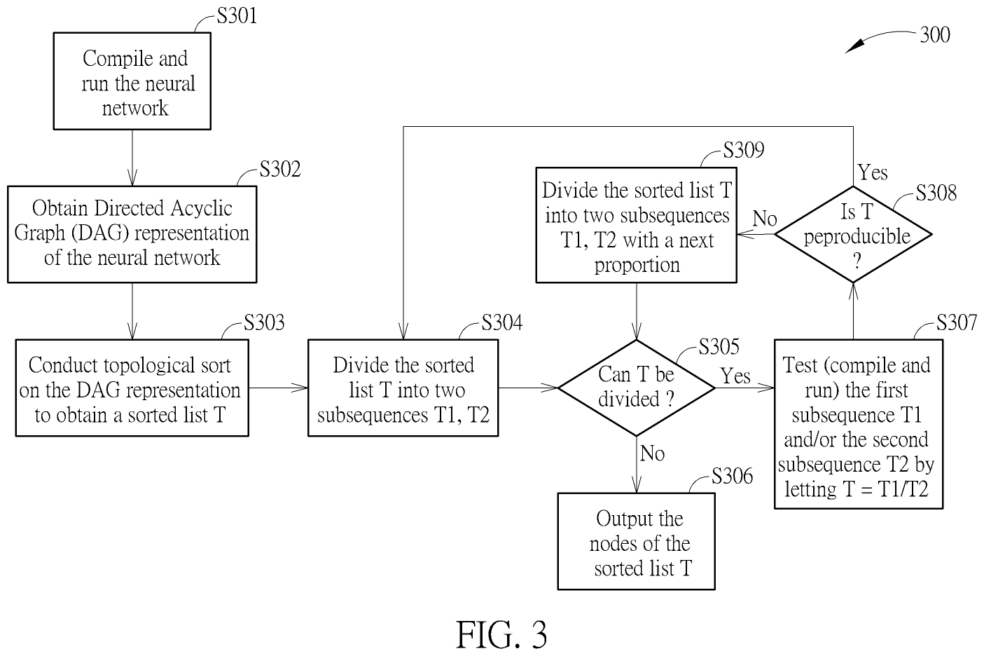

FIG. 3 is a flowchart of a method 300 for operation of a reference processor and the network reducer 12. The reference processor is used to provide reference tensors for different layers of the neural network. In this flowchart, it is supposed that the neural network has at least one compiling bug. The method 300 comprises the following steps:
Step S301: Compile and run the neural network on a reference processor to obtain the reference tensor of each layer;
Step S302: Obtain Directed Acyclic Graph (DAG) representation of the neural network, in which each layer is a node, and the relationship between every two layers is an edge;
Step S303: Conduct topological sort on the DAG representation to obtain a sorted list T (e.g. the neural network 100), and use the sorted list T as an initial input sequence;
Step S304: Divide the sorted list T into two subsequences T1, T2 (e.g. the sub-networks 142, 144);
Step S305: Check if the sorted list T can be further divided; if so, go to Step S307; else go to Step S306;
Step S306: Output the nodes of the sorted list T and terminate the network reducer.
Step S307: Test (compile and run) the first subsequence T1 and/or the second subsequence T2;
Step S308: If the first subsequence T1 is reproducible, let the sorted list T=the first subsequence T1, and go to Step S304; if the second subsequence T2 is reproducible, let the sorted list T=the second subsequence T2, and go to Step S304. If neither the first subsequence T1 nor the second subsequence T2 can reproduce the compiling errors, go to Step S309;
Step S309: Divide the sorted list T into two subsequences T1, T2 with a next proportion different from Step S304.

Step S301 is performed on the reference processor. Steps S302-S309 are performed on the network reducer 12.

In Steps S304 and S309, the sorted list T can be divided in the following sequence:

$$< \{ \frac{1}{{2}^{i}} , \frac{{2}^{i} - 1}{{2}^{i}} \} \vert i = 1 , 2 , 3 , … , t , where {2}^{t} \leq T . size ( ) > ex . \frac{1}{2} , \frac{1}{4} , \frac{3}{4} , \frac{1}{8} , \frac{7}{8} ,$$

That is, in Step S304, the number of layers of the first subsequence T1 is approximately half of the number of layers of the sorted list T, and the number of layers of the second subsequence T2 is approximately half of the number of layers of the sorted list T. In the first iteration of Step S309, the number of layers of the first subsequence T1 is approximately ¼ of the number of layers of the sorted list T, and the number of layers of the second subsequence T2 is approximately ¾ of the number of layers of the sorted list T. In the second iteration of Step S309, the number of layers of the first subsequence T1 is approximately ¾ of the number of layers of the sorted list T, and the number of layers of the second subsequence T2 is approximately ¼ of the number of layers of the sorted list T. In the third iteration of Step S309, the number of layers of the first subsequence T1 is approximately ⅛ of the number of layers of the sorted list T, and the number of layers of the second subsequence T2 is approximately ⅞ of the number of layers of the sorted list T. In the fourth iteration of Step S309, the number of layers of the first subsequence T1 is approximately ⅞ of the number of layers of the sorted list T, and the number of layers of the second subsequence T2 is approximately ⅛ of the number of layers of the sorted list T, and so on. The complexity of this network reducer 12 is thus O(log N), reducing time consumption and covering sufficient possibility.

In Step S307, if the first subsequence T1 can reproduce the compiling errors, then testing of the second subsequence T2 can be skipped. If the first subsequence T1 cannot reproduce the compiling errors, then the second subsequence T2 would be tested to see if the second subsequence T2 can reproduce the compiling errors.

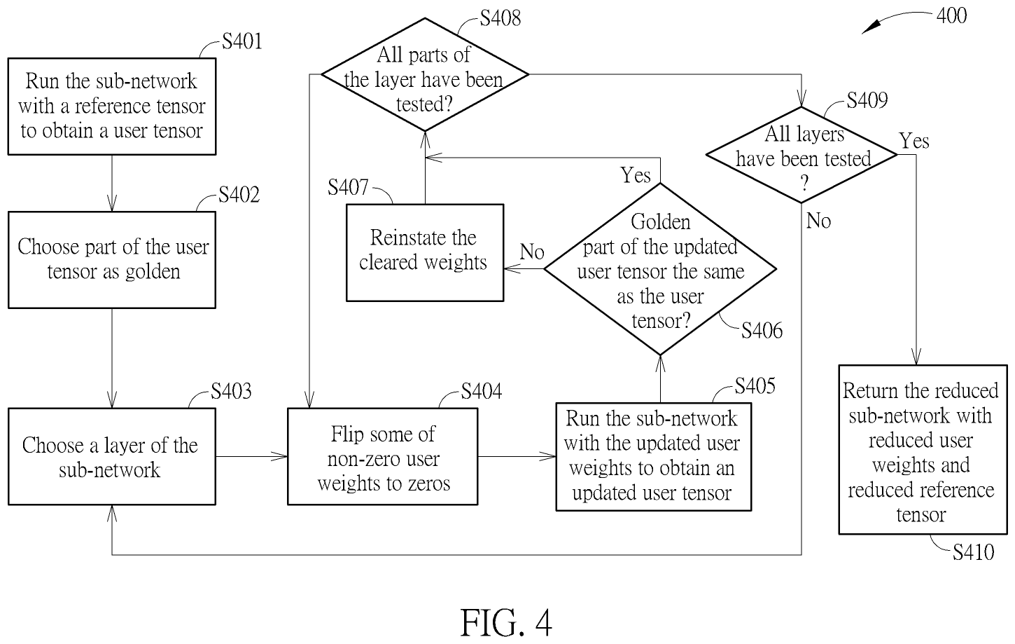

FIG. 4 is a flowchart of a method 400 for operation of the data reducer 14. The method 400 comprises the following steps:
Step S401: run the sub-network with a reference tensor to obtain a user tensor;
Step S402: choose part of the user tensor as golden, the remaining part can thus be flipped to zeros;
Step S403: choose a layer of the sub-network according to a reverse topological order or topological order;
Step S404: flip some of non-zero user weights of the layer of the sub-network to zeros to obtain updated user weights while retaining the user weights as cleared weights;
Step S405: run the sub-network with the updated user weights to obtain an updated user tensor;
Step S406: check if the golden part of the updated user tensor is the same as the user tensor in Step S401 by using a region of interest (ROI) mask; if so, go to Step S408; else go to Step S407;
Step S407: reinstate the cleared weights;
Step S408: check if all non-zero user weights of the layer have been tested; if so, go to Step S409; else go to Step S404;
Step S409: check if all layers have been tested; if so, go to Step S410; else go to Step S403;
Step S410: return the reduced sub-network with reduced user weights and reduced reference tensor that can be used to reproduce the compiling errors.

In an example for the method 400, the reference tensor is assumed to be {{1,1,0,2}}, the user weights of the layer of the sub-network in Step S403 is assumed to be {{2,−1,0}, {2,1,1}, {4,1,1}}, the user tensor in Step S401 with an error is {{1,2}, {3,9}, {5,6}}, and the reference tensor outputted by the last layer of the sub-network when compiled by the reference compiler is {{1,2}, {3,4}, {5,6}}. The different part between the reference tensor and the user tensor with an error generates the ROI mask {0,0}, {0,1}, {0,0}. This shows that the golden part of the user tensor is the second element of the second array of the user tensor. In an example, one of the element in the user weights is flipped to zero, thus the updated user weights become {{2,−1,0}, {2,1,0}, {4,1,1}} in Step S404. The updated user weights {{2,−1,0}, {2,1,0}, {4,1,1}} are convoluted with the reference tensor {{1,1,0,2}} with an assumed error to generate the updated user tensor {{1,2}, {3,6}, {5,6}} in Step S405. In Step S406, the updated user tensor {{1,2}, {3,6}, {5,6}} is filtered with the ROI mask {0,0}, {0,1}, {0,0} to generate {0,0}, {0,6}, {0,0}. The second element of the second array which is 6 is different from the user tensor with an assumed error (i.e., 9). Therefore, Step S407 is to be performed to reinstate the cleared weights {{2,−1,0}, {2,1,1}, {4,1,1}}. In Step S408, suppose not all non-zero user weights of the layer have been tested, Step S404 is performed to flip the first element of the third array to obtain updated user weights {{2,−1,0}, {2,1,1}, {0,1,1}}. In Step S405, the result of convolution with an assumed error is {{1,2}, {3,9}, {1,2}}. In Step S406, the updated user tensor {{1,2}, {3,9}, {1,2}} is filtered with the ROI mask {{0,0}, {0,1}, {0,0}} to generate {{0,0}, {0,9}, {0,0}}. The second element of the second array which is 9 is the same as the user tensor with an assumed error (i.e., 9). Therefore, the first element of the third array of the user weights of the layer can be flipped to zero, becoming {{2,−1,0}, {2,1,1}, {0,1,1}}.

In conclusion, a neural network compiled by using user compiler with unknown bugs can be reduced by the network reducer of the neural network bug identifier to generate a sub-network. The sub-network with the user weights and the reference tensor can be further reduced by the data reducer of the neural network bug identifier to generate the reduced reference tensor and reduced user weights. The present invention provides a neural network bug identifier to efficiently find out the bugs and output a sub-network with reduced user weights and reduced reference tensor.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for reducing a neural network comprising:
compiling the neural network by a reference compiler to rearrange reference weights;
manipulating a reference tensor inputted to the neural network with the reference weights to output a reference tensor for each layer of the neural network;
compiling the neural network by a user compiler to rearrange user weights;
manipulating the reference tensor inputted to the neural network with the user weights to output a user tensor for the neural network;
if a reference tensor of a last layer of the neural network is inconsistent with the user tensor, then a network reducer sorting and partitioning the neural network into a plurality of sub-networks each containing at least one layer;
compiling the plurality of sub-networks to rearrange user weights of the sub-networks; and
manipulating a reference tensor inputted to a corresponding sub-network with corresponding user weights to output a user tensor.

2. The method of claim 1 wherein the network reducer partitions the neural network into the plurality of sub-networks according to a result of sorting the neural network.

3. The method of claim 1 further comprising if the user tensor is inconsistent with a corresponding reference tensor, the network reducer partitioning the sub-network into a plurality of minor sub-networks each containing at least one layer.

4. The method of claim 1 further comprising obtaining a directed acyclic graph (DAG) representation of the neural network.

5. The method of claim 4 wherein the network reducer sorts the neural network by performing a topological sort on the DAG representation to obtain a sorted list.

6. The method of claim 5 wherein the network reducer partitioning the neural network into a plurality of sub-networks is the network reducer partitioning the sorted list into two subsequences.

7. The method of claim 6 wherein compiling the plurality of sub-networks to rearrange the user weights of the sub-networks is compiling the two subsequences to rearrange user weights of the two subsequences.

8. The method of claim 7 wherein manipulating the reference tensor inputted to the corresponding sub-network with the corresponding user weights to output the user tensor is running a subsequence with the reference tensor and the corresponding user weights to output the user tensor.

9. The method of claim 1 further comprising if the user tensor is inconsistent with a corresponding reference tensor, and the network reducer is unable to further partition the sub-network, then outputting the sub-network to a data reducer.

10. The method of claim 9 further comprising choosing part of the user tensor as golden.

11. The method of claim 9 further comprising the data reducer simplifying the reference tensor inputted to the corresponding sub-network and simplifying corresponding user weights.

12. The method of claim 11 wherein the data reducer simplifying the reference tensor inputted to the corresponding sub-network and simplifying the corresponding user weights comprises:
identifying which of the corresponding user weights are redundant weights; and
flipping the redundant weights to zeros.

13. The method of claim 12 wherein the redundant weights are identified one by one in a topological order.

14. The method of claim 12 wherein the redundant weights are identified one by one in a reverse topological order.

15. The method of claim 12 wherein identifying which of the corresponding user weights are redundant weights is performed by using a region of interest (ROI) mask and a differential test.
